(19) United States
(12) Patent Application Publication
(10) Pub. No.: US 2008/0037277 A1
(43) Pub. Date: Feb. 14, 2008

(54) Operation Device

(75) Inventors: Tatsuyuki Yamaguchi, Aichi (JP); Akihito Miyagawa, Aichi (JP); Jyunya Wakabayashi, Aichi (JP)

Correspondence Address: CROMPTON, SEAGER & TUFTE, LLC, 1221 NICOLLET AVENUE, SUITE 800, MINNEAPOLIS, MN, 55403-2420, US

(73) Assignee: KABUSHIKI KAISHA TOKAI RIKA DENKI SEISAKUSHO, Aichi (JP)

(21) Appl. No.: 11/782,804

(22) Filed: Jul. 25, 2007

(30) Foreign Application Priority Data
Aug. 9, 2006 (JP) 2006-216968

(51) Int. Cl. F21V 7/04

(52) U.S. Cl. 362/611

(57) ABSTRACT

A single light source arranged in the central portion of an operation device illuminates operation portions and illumination windows of the operation device. The light emitted from the light source is reflected by a reflection surface of an elastic sheet into an inner side surface of a light guide plate. The light guide plate includes a plurality of light redirection areas for redirecting the light toward the illumination windows.

### CROSS-REFERENCE TO RELATED APPLICATIONS

This application is based upon and claims the benefit of priority from prior Japanese Patent Application No. 2006-216968, filed on Aug. 9, 2006, the entire contents of which are incorporated herein by reference.

### BACKGROUND OF THE INVENTION

The present invention relates to an operation device having a function for illuminating an operation portion.

A typical operation device arranged in, for example, a passenger compartment of a vehicle illuminates an operation portion during the nighttime. This enables the position of the operation portion to be identified.

Referring to FIG. 5, an operation device 51 of the prior art includes a cover panel 53 and a switch assembly 54, which is arranged at the rear side of the cover panel 53. The cover panel 53 includes a plurality of operation portions 52. A plurality of illumination windows 57 are respectively arranged adjacent to the plurality of operation portions 52. The switch assembly 54 includes a circuit board 55 and an elastic sheet 56 covering the circuit board 55. The circuit board 55 includes switch elements respectively located at positions corresponding to the operation portions 52. The circuit board 55 also includes a plurality of light sources 58, such as top-view type LEDs, respectively located at positions corresponding to the illumination windows 57.

Each light source 58 emits light through the corresponding illumination window 57 and out of the cover panel 53. The light also illuminates the corresponding operation portion 52. This enables recognition of the operation portion 52 during the nighttime.

However, the operation device 51 of the prior art requires each operation portion 52 to be provided with the light source 58. This increases the components mounted on the circuit board 55, enlarges the circuit board 55, and imposes restrictions on the component layout of the circuit board 55. Further, the light sources 58 may have different qualities. In such a case, the light brightness would differ between operation portions 52.

Japanese Laid-Out Patent Publication No. 8-194219 describes an operation device that uses a light guide to illuminate a plurality of illumination windows with a single light source.

Referring to FIG. 6A, an operation device 61 includes a light guide plate 62, which is arranged between a cover panel 53 and an elastic sheet 56. A light source 63, such as a side view type LED, is arranged beside the light guide plate 62. As shown in FIG. 6B, the light guide plate 62 includes a plurality of recesses 64 formed at portions corresponding to illumination windows 57. The light source 63 emits light that enters one end of the light guide plate 62. The recesses 64 reflect the light toward the corresponding illumination windows 57.

In the side-view type operation device 61, the light source 63 and a board 65, which is used to activate the light source 63, must be arranged beside the light guide plate 62. This enlarges the operation device 61 and the distance from the light source 63 varies between the plurality of illumination windows 57. As a result, it becomes difficult to illuminate the plurality of illumination windows 57 with light having the same brightness.

### SUMMARY OF THE INVENTION

The present invention provides a compact and simple operation device that illuminates a plurality of illumination windows and has a high level of design freedom.

One aspect of the present invention is an operation device provided with a cover panel including a plurality of operation portions and a plurality of illumination windows. A planar elastic member is arranged inward from the cover panel, with the elastic member including a plurality of resiliently deformable portions respectively corresponding to the operation portions of the cover panel and resiliently deformed when the operation portions are operated. A circuit board is covered by the elastic member, with the circuit board including a plurality of switch elements and at least one light source. Deformation of the plurality of deformable portions of the elastic member respectively open and close the plurality of switch elements. The at least one light source emits light for illuminating the plurality of illumination windows. The at least one light source is less in number than the plurality of illumination windows. The at least one light source emits light in an emission direction perpendicular to the circuit board. The plurality of illumination windows emit light in a direction that is the same as the emission direction. A planar light guide member is arranged perpendicular to the emission direction of the at least one light source. The light guide member guides light emitted from the at least one light source to the plurality of illumination windows. A reflection surface is arranged on at least either one of the cover panel and the elastic member. The reflection surface reflects light emitted from the at least one light source toward an inner side surface of the light guide member.

A further aspect of the present invention is an operation device including a plurality of operation portions, a plurality of illumination windows respectively illuminating the operation portions, and a circuit board. A plurality of switch elements are arranged on the circuit board and respectively correspond to the operation portions. A single light source is arranged on the circuit board equally distanced from the switch elements, with the light source including an emission surface from which light is emitted in a direction perpendicular to the circuit board. A transparent or semi-transparent elastic sheet is arranged on the circuit board and has an opening for receiving the light source. A light guide plate is arranged on the elastic sheet, with the light guide plate including a light redirection areas and an insertion hole. The light redirection areas are formed at locations corresponding to the plurality of illumination windows. The insertion hole is defined by an inner side surface in the light guide plate. A reflective projection faces toward the emission surface of the light source, with the reflective projection including an inclined reflection surface for reflecting light emitted from the light source into the inner side surface of the light guide plate.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is an exploded perspective view showing an operation device according to a preferred embodiment of the present invention;

FIG. 2 is a cross-sectional view taken along line 2-2 in FIG. 1;

FIG. 3 is an enlarged cross-sectional view of the operation device shown in FIG. 1;

FIG. 4 is a cross-sectional view of a modification of the operation device shown in FIG. 1;

FIG. 5 is a cross-sectional view of a prior art operation device;

FIG. 6A is a cross-sectional view of a further prior art operation device; and

FIG. 6B is a diagram showing light redirected by recesses of the light guide plate.

### DETAILED DESCRIPTION OF THE PREFERRED EMBODIMENTS

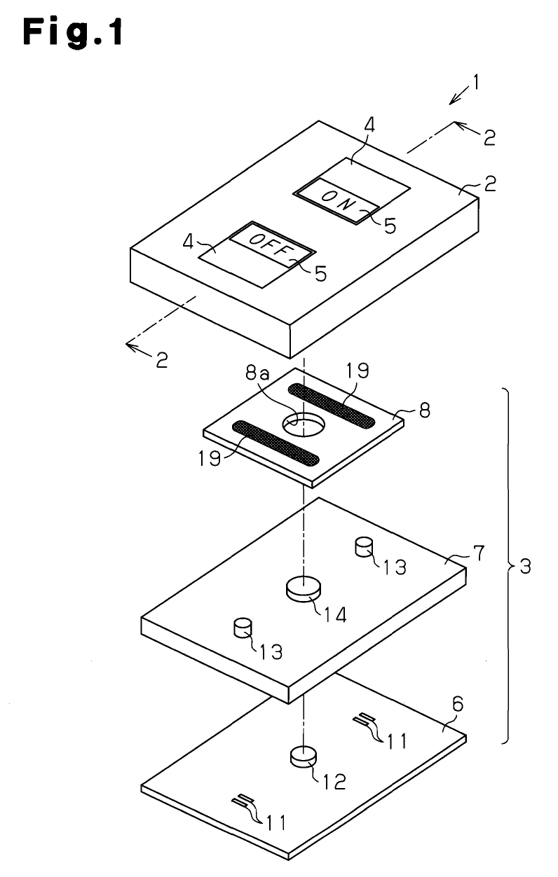

An operation device 1 according to a preferred embodiment of the present invention will now be discussed with reference to FIGS. 1 to 3.

Referring to FIG. 1, the operation device 1 includes a cover panel 2 and a switch assembly 3, which is arranged at the rear side (lower side as viewed in FIG. 1) of the cover panel 2. The operation device 1 is arranged, for example, near the driver's seat in a vehicle on a steering wheel or a dashboard.

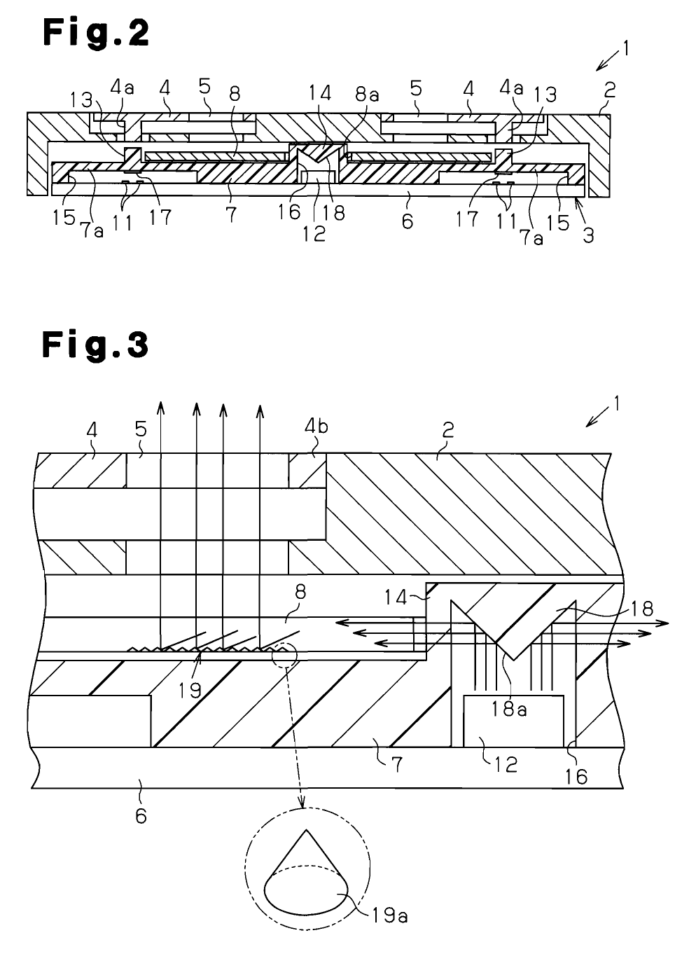

As shown in FIG. 2, a plurality of (for example, two) operation portions 4 are exposed from the outer surface of the cover panel 2. Each operation portion 4 is supported by a hinge 4b (FIG. 3) in a manner tiltable relative to the cover panel 2. The operation portion 4 may be formed integrally with the cover panel 2.

An activation projection 4a extends downward from each operation portion 4. Each operation portion 4 includes a transparent or semi-transparent illumination window 5. The illumination window 5 may be a member that is independent from the corresponding operation portion 4 and arranged adjacent to that operation portion 4.

The letters “ON” are printed on one of the operation portions 4, and the letters “OFF” are printed on the other operation portion 4. The two illumination windows 5 receive light from a light source, or LED 12. This brightens the letters of the two illumination windows 5 and entirely illuminates the two operation portions 4.

Referring to FIGS. 1 and 2, the switch assembly 3 includes a circuit board 6, an elastic sheet 7, and a light guide plate 8. The elastic sheet 7 is a planar elastic member formed of an elastomeric material and arranged on the circuit board 6. The light guide plate 8 is arranged on the elastic sheet 7.

The circuit board 6 has an upper surface including two fixed contact pairs 11 respectively corresponding to the two operation portions 4. Each of the fixed contact pairs 11 functions as a switch element. The light source, or the top view type LED 12, is arranged on the circuit board 6. The LED 12 emits light in a direction perpendicular to the plane of the circuit board 6. In the illustrated embodiment, the LED 12 is arranged along a line connecting the two fixed contact pairs 11. It is preferred that the LED 12 be arranged closer to the center of the circuit board 6 than the two fixed contact pairs 11 and the two illumination windows 5. Further, it is preferred that the illumination windows 5 be separated from the LED 12 by the same distance.

The elastic sheet 7, which is transparent or semi-transparent, is formed from a resilient soft resin such as silicone rubber. The elastic sheet 7 covers the entire upper surface of the circuit board 6. The elastic sheet 7 may be dimensioned so that it covers at least the fixed contact pairs 11. The elastic sheet 7 includes first projections 13 pressed by the activation projections 4a of the operation portions 4, respectively.

The elastic sheet 7 further includes a hollow second projection 14, which is located at a position corresponding to the LED 12 of the circuit board 6. An open round light source compartment 16 is defined below the second projection 14 of the elastic sheet 7 to accommodate the LED 12.

As shown in FIG. 2, the elastic sheet 7 includes diaphragms 7a arranged in correspondence with the operation portions 4. The first projections 13 are respectively formed on the upper surfaces of the diaphragms 7a. The diaphragms 7a each define a contact compartment 15. The contact compartments 15 each accommodate each one of the fixed contact pairs 11. A movable contact 17 is arranged at the bottom surface of each of the diaphragms 7a.

When one of the operation portions 4 is pushed, the corresponding activation projection 4a pushes the first projection 13 and resiliently deforms the associated diaphragm 7a of the elastic sheet 7. The resilient deformation of the diaphragm 7a causes contact between the corresponding movable contact 17 and fixed contact pair 11. As a result, the fixed contact pair 11 becomes conductive. When the operation portion 4 is released, the elastic sheet 7 (diaphragm 7a) returns to its original form, and the movable contact 17 becomes spaced from the fixed contact pair 11. In this manner, the pushing of the operation portion 4 opens and closes the fixed contact pair 11.

A reflective projection 18 is arranged in the light source compartment 16 facing towards the light emission surface of the LED 12. The reflective projection 18 reflects the light emitted from the LED 12. The reflective projection 18 is tapered and has a distal end directed toward the LED 12. Further, the reflective projection 18 has a side surface functioning as a reflection surface 18a.

The light guide plate 8 is formed from a light guiding material such as a transparent acrylic resin, a transparent styrene resin, and a transparent urethane resin. The light guide plate 8 is arranged parallel to the elastic sheet 7. The light guide plate 8 extends to at least overlap each one of the illumination windows 5.

The light guide plate 8 includes an insertion hole 8a located at a position corresponding to the second projection 14. In the illustrated embodiment, the insertion hole 8a extends through the central portion of the light guide plate 8. The inner surface defining the insertion hole 8a functions as an inner side surface arranged in the light guide plate 8. The inner side surface may be arranged at the central portion of the light guide plate 8. When the light guide plate 8 is arranged on the elastic sheet 7, the second projection 14 is inserted through the insertion hole 8a.

Referring to FIGS. 1 and 3, the light guide plate 8 includes a plurality of light redirection areas 19 located at positions corresponding to the plurality of illumination windows 5. The light redirection areas 19 reflect the light guided into the light guide plate 8 toward the corresponding illumination window 5. As shown in FIG. 3, each light redirection area 19 is formed by a plurality of fine conical recesses 19a. The fine conical recesses 19a each have a diameter and depth of, for example, several micrometers to several tens of micrometers. Further, the fine conical recesses 19a each provide a reflection surface for reflecting light toward the corresponding illumination window 5. The light redirection areas 19 may be formed on the lower surface of the light guide plate 8 facing toward the elastic sheet 7 or on the upper surface of the light guide plate 8 facing toward the illumination windows 5. The fine conical recesses 19a do not have to be conical and may be formed to be, for example, pyramidal or cylindrical.

The operation of the operation device 1 will now be discussed. The arrows shown in FIG. 3 indicate the path of the light emitted from the LED 12.

The LED 12 first emits light in a direction perpendicular to the plane of the circuit board 6. The light is reflected by the reflection surface 18a of the reflective projection 18. As a result, the light enters the light guide plate 8 from the inner side surface of the light guide plate 8 (i.e., the inner surface defining the insertion hole 8a). As the light travels through the light guide plate 8, the light is reflected and dispersed. The light is reflected by the reflection surface of each fine conical recess 19an in the light redirection areas 19 and emitted from the light guide plate 8 through the illumination windows 5. The emitted light exits the cover panel 2 through the illumination windows 5.

The preferred embodiment has the advantages described below.

(1) The LED 12 is located on the circuit board 6, on which the fixed contact pairs 11 are arranged. This eliminates the need for an exclusive board (e.g., the board 65 shown in FIG. 6) to activate the LED 12. The LED 12 emits light in the same direction as the direction in which light is emitted from the illumination windows 5. Further, the light guide plate 8 extends between the LED 12 and the illumination windows 5. Thus, the LED 12 does not have to be arranged beside the light guide plate 8 like in the prior art, and the plurality of illumination windows 5 may be illuminated by the single LED 12. Accordingly, the number of components in the operation device 1 may be kept low, and the operation device does not have to be enlarged. Further, the LED 12 does not have to be arranged at a position corresponding to an illumination window 5. Thus, a high level of freedom is provided for the layout of the LED 12 on the circuit board 6.

(2) The illumination windows 5 are spaced from the LED 12 by equal distances. This illuminates the two illumination windows 5 with the same brightness. The position of the LED 12 is not limited as long as the illumination windows 5 are spaced by the same distance from the LED 12. Thus, a high level of freedom is provided for the layout of the LED 12 on the circuit board 6.

(3) The reflective projection 18 is tapered and has a distal end directed toward the LED 12. The reflective projection 18, which has a simple structure, ensures that the light emitted from the LED 12 is reflected toward the inner side surface of the light guide plate 8.

(4) The reflective projection 18 is arranged on the elastic sheet 7, which covers the LED 12. When the entire circuit board 6 is substantially covered by the elastic sheet 7, waterproof and dustproof effects are obtained. This protects the LED 12 and the circuit board 6 from moisture and dust.

(5) The push-type operation device 1 originally requires the contact compartment 15. Thus, even if the LED 12 is attached to the circuit board 6, the thickness of the operation device 1 remains substantially the same. More specifically, when attaching the LED 12 to the circuit board 6, void, or the light source compartment 16, becomes necessary for the accommodation of the LED 12 and the reflective projection 18. However, the push-type operation device 1 requires the contact compartments 15, which are voids provided in the elastic sheet 7 to enable movement of the movable contacts 17 toward and away from the corresponding fixed contact pairs 11. The difference in height between the contact compartment 15 and the light source compartment 16 is small. Thus, the thickness of the operation device 1 is not increased from the thickness of the prior art device.

It should be apparent to those skilled in the art that the present invention may be embodied in many other specific forms without departing from the spirit or scope of the invention. Particularly, it should be understood that the present invention may be embodied in the following forms.

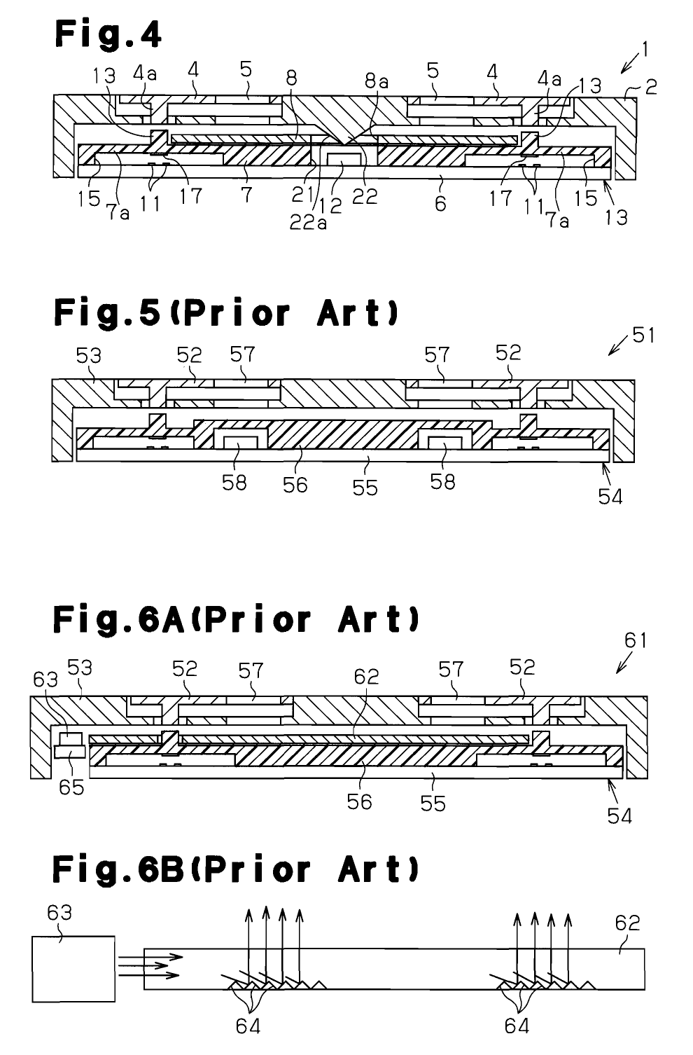

The reflective projection 18 does not have to be provided on the elastic sheet 7. In the example shown in FIG. 4, the elastic sheet 7 has an insertion hole 21, which functions as an opening for receiving the LED 12. The cover panel 2 has a reflective projection 22 arranged at a position facing towards the LED 12. The reflective projection 22 is tapered and has a peak directed toward the LED 12. The reflective projection 22 has a side surface that functions as a reflection surface 22a. In this case, the light emitted from the LED 12 is also reflected by the reflection surface 22a of the reflective projection 22 so as to enter an inner side surface of the light guide plate 8 (i.e., the inner surface defining the insertion hole 8a). In the example of FIG. 4, the elastic sheet 7 includes only the insertion hole 21 in lieu of the light source compartment 16 and the reflective projection 18. This simplifies the structure of the elastic sheet 7.

Reflection material having a high level of light reflectivity may be applied to the reflection surfaces 18a and 22a of the reflective projections 18 and 22. Alternatively, the reflection surfaces 18a and 22a may be coated by a reflection agent. In such cases, light is effectively reflected toward the light guide plate 8.

The reflective projections 18 and 22 do not have to be tapered as long as they are shaped to enable the light emitted from the LED 12 to enter the wall defining the insertion hole 8an in the light guide plate 8. For example, the reflective projections 18 and 22 may be triangular prisms. In this case, the inclined surfaces of the triangular prism function as reflection surfaces for reflecting the light emitted from the LED 12 toward the wall defining the insertion hole 8a.

The illumination windows 5 do not have to be arranged in the corresponding operation portions 4 and may be arranged near the operation portions 4 of the cover panel 2.

The light guide plate 8 does not have to be arranged above the elastic sheet 7 and may be arranged, for example, between the elastic sheet 7 and the circuit board 6 (LED 12).

The LED 12 does not necessarily have to be arranged at a position where the distance from each illumination window 5 is the same.

There may be three or more illumination windows 5. In this case, it is preferred that the LED 12 be arranged within a zone surrounded by the illumination windows 5. It is preferred that the LED 12 be arranged so that at least two of the illumination windows 5 are spaced by the same or substantially the same distance from the LED 12.

The operation portions 4 do not have to be of a push type but may be of, for example, a slide type or a seesaw type.

The light redirection areas 19 of the light guide plate 8 do not have to be arranged on the lower side of the light guide plate 8 and may be arranged on the upper side or both the upper and lower sides of the light guide plate 8.

The light source is not limited to the LED 12 and may be any light emitting body that emits light in a direction perpendicular to the light guide plate 8, such as an incandescent lamp bulb or an electroluminescence (EL) element.

The cover panel 2 may be part of a housing, such as a box, or a flat plate.

The present examples and embodiments are to be considered as illustrative and not restrictive, and the invention is not to be limited to the details given herein, but may be modified within the scope and equivalence of the appended claims.

What is claimed is:

1. An operation device comprising:
a cover panel including a plurality of operation portions and a plurality of illumination windows;
a planar elastic member arranged inward from the cover panel, with the elastic member including a plurality of resiliently deformable portions respectively corresponding to the operation portions of the cover panel and resiliently deformed when the operation portions are operated;
a circuit board covered by the elastic member, with the circuit board including a plurality of switch elements and at least one light source, wherein deformation of the plurality of deformable portions of the elastic member respectively open and close the plurality of switch elements, the at least one light source emits light for illuminating the plurality of illumination windows, the at least one light source is less in number than the plurality of illumination windows, the at least one light source emits light in an emission direction perpendicular to the circuit board, and the plurality of illumination windows emit light in a direction that is the same as the emission direction;
a planar light guide member arranged perpendicular to the emission direction of the at least one light source, wherein the light guide member guides light emitted from the at least one light source to the plurality of illumination windows; and
a reflection surface arranged on at least either one of the cover panel and the elastic member, wherein the reflection surface reflects light emitted from the at least one light source toward an inner side surface of the light guide member.

2. The operation device according to claim 1, wherein the at least one light source is a single light source arranged to be equally distanced from at least two of the plurality of illumination windows.

3. The operation device according to claim 1, wherein:
at least one of the cover panel and the elastic member includes a tapered reflective projection having a distal end directed toward the at least one light source; and
the tapered reflective projection includes a tapered surface functioning as the reflection surface.

4. The operation device according to claim 1, wherein the reflection surface is coated by a light reflection agent.

5. The operation device according to claim 1, wherein the at least one light source is arranged within a zone surrounded by the plurality of illumination windows.

6. An operation device comprising:
a plurality of operation portions;
a plurality of illumination windows for respectively illuminating the operation portions;
a circuit board;
a plurality of switch elements arranged on the circuit board and respectively corresponding to the operation portions;
a single light source arranged on the circuit board equally distanced from the switch elements, with the light source including an emission surface from which light is emitted in a direction perpendicular to the circuit board;
a transparent or semi-transparent elastic sheet arranged on the circuit board and having an opening for receiving the light source;
a light guide plate arranged on the elastic sheet, with the light guide plate including a light redirection areas and an insertion hole, wherein the light redirection areas are formed at locations corresponding to the plurality of illumination windows, and the insertion hole functioning as an inner side surface is formed in the light guide plate; and
a reflective projection facing toward the emission surface of the light source, with the reflective projection including an inclined reflection surface for reflecting light emitted from the light source into the inner side surface of the light guide plate.

7. The operation device according to claim 6, wherein the reflective projection is formed integrally with the elastic sheet.

8. The operation device according to claim 7, wherein the reflective projection is tapered and has a distal end directed toward the emission surface of the light source.

9. The operation device according to claim 6, further comprising:
a cover panel covering the circuit board, the elastic sheet, and the light guide plate, wherein the elastic projection is formed integrally with the cover panel.

10. The operation device according to claim 9, wherein the reflective projection is tapered and has a distal end directed toward the emission surface of the light source.

11. The operation device according to claim 6, wherein the operation portions are each of a push type and the elastic sheet includes a plurality of diaphragms arranged between the plurality of switch elements and the plurality of operation portions, with each of the diaphragms being resiliently deformed when the corresponding operation portion is pushed.

12. The operation device according to claim 6, wherein the operation device includes a side surface, and distance of the side surface of the operation device to the light source is greater than distance of the side surface of the operation device to each of the illumination windows.

13. The operation device according to claim 12, wherein the light source is arranged near the center of the operation device.

14. The operation device according to claim 6, wherein the illumination windows are each formed integrally with the corresponding operation portions.

15. The operation device according to claim 6, wherein the illumination windows are each formed near the corresponding operation portions.

16. The operation device according to claim 6, wherein the operation device is a switch operation device.
